(19) United States
(12) Patent Application Publication
(10) Pub. No.: US 2016/0043583 A1
(43) Pub. Date: Feb. 11, 2016

(54) BATTERY PACK, MOBILE BODY, AND CONTROL METHOD THEREOF

(71) Applicant: NEC ENERGY DEVICES, LTD., Kanagawa (JP)

(72) Inventor: Tadahiro YOSHIDA, Sagamihara-shi (JP)

(73) Assignee: NEC Energy Devices, Ltd., Sagamihara-shi, Kanagawa (JP)

(21) Appl. No.: 14/774,406

(22) PCT Filed: Feb. 14, 2014
(86) PCT No.: PCT/JP2014/053405

§ 371 Date: Sep. 10, 2015

(30) Foreign Application Priority Data
Mar. 13, 2013 (JP) 2013-050084

(51) Int. Cl. H02J 7/00

(52) U.S. Cl. CPC H02J 7/0026; H02J 7/0021; H02J 7/007

(57) ABSTRACT

Provided is a battery pack capable of solving a problem in which driving becomes unstable. Switches (21, 22) switch between starting and stopping the current flow between secondary battery cells (11) and an external device. Detectors (23 to 26) detect a state value indicating a state of the battery pack (200). A manager (27) determines whether or not an abnormality has occurred in the battery pack based on the state value, and if an abnormality has occurred, transmits an abnormality signal indicating the occurrence of abnormality to the external device, and subsequently after a predefined delay time passes, outputs an interruption instruction to interrupt the current flow between the secondary battery cells (11) and the external device. An interrupter (26) interrupts the current flow between the secondary battery cells (11) and the external device via the switches (21, 22) if the interruption instruction is outputted. The delay time is five or more seconds.

### TECHNICAL FIELD

The present invention relates to a battery pack including secondary battery cells, and more particularly, to a battery pack including lithium ion secondary battery cells.

### BACKGROUND ART

As power sources of electric equipment, lithium ion secondary battery cells have recently attracted attention. Lithium ion secondary battery cells have a high energy density, thus providing an advantage of reduced size and weight, but at the same time, the lithium ion secondary battery cells may become damaged due to overcharge or over discharge. Hence, lithium ion secondary battery cells are usually used as a battery pack equipped with a protective circuit (BMU: battery management unit) for protecting the lithium ion secondary battery cells.

A protective circuit monitors the state of lithium ion secondary battery cells, and based on the state, interrupts the current flow between lithium ion secondary battery cells and the external device before the lithium ion secondary battery cells become damaged. More specifically, the protective circuit monitors voltage between both electrodes of the lithium ion secondary battery cells, current flowing to the lithium ion secondary battery cells, and the temperature of the lithium ion secondary battery cells as states of the lithium ion secondary battery cells, and if these values exceed predetermined threshold values, the current flow between the lithium ion secondary battery cells and the external device is forcibly shut down, thereby preventing the lithium ion secondary battery cells from becoming damaged.

However, if the current flowing between the lithium ion secondary battery cells and the external device is interrupted at the moment when the above values exceed the corresponding threshold values, power supply to the electric equipment is suddenly stopped, which causes a problem in which the data being processed will be corrupted, or the like in the electric equipment performing data processing, such as a personal computer and a mobile phone.

To counter this, Patent Document 1 discloses an over discharge prevention apparatus that outputs a signal to the electric equipment indicating that power supply will be stopped if voltage exceeds a threshold value for the purpose of securing enough time for the electric equipment to back up data being processed onto a hard disk or the like, and subsequently after approximately several milliseconds to several hundred milliseconds pass, interrupts the current supply between the battery cells and the external device.

### RELATED ART DOCUMENTS

### Patent Document

Patent Document 1: JP09-215213 A

### SUMMARY

### Technical Problem

In the case of using the above battery pack as a power source of a mobile body of a power assisted electric bicycle or the like, there is a problem that if power supply to the electric equipment is suddenly stopped by the protective circuit, power that is applied to pedals of the power assisted electric bicycle or a steering wheel of an electric vehicle is suddenly changed which results in the driving conditions of the vehicle becoming unstable.

In the over discharge prevention apparatus described in Patent Document 1, there is spare time of several milliseconds to several hundred milliseconds until the power supply to the electric equipment is stopped after the voltage exceeds the threshold value, but in such a short time, a user cannot recognize in advance any change in the amount of power, therefore, it is not possible to solve the problem in which driving conditions of the vehicle become unstable.

An object of the present invention, which has been made in order to solve the above problem, is to provide a battery pack, a mobile body, and a control method capable of solving the problem in which the driving conditions of the vehicle become unstable.

### Solution to Problem

A battery pack according to an exemplary aspect of the present invention is a battery pack including secondary battery cells,

the battery pack including:

a switch that switches between starting and stopping the current flow between the secondary battery cells and an external device;

a detector that detects a state value that indicates a state of the battery pack;

a manager that determines whether or not an abnormality has occurred in the battery pack based on the state value, and if the abnormality has occurred, transmits an abnormality signal indicating the occurrence of abnormality to the external device, and subsequently after a predefined delay time passes, outputs an interruption instruction to interrupt the current flow between the secondary battery cells and the external device; and

an interrupter that interrupts the current flow between the secondary battery cells and the external device via the switch if the interruption instruction is outputted, wherein the delay time is five or more seconds.

A mobile body according to an exemplary aspect of the present invention includes the above battery pack.

A control method of the battery pack according to an exemplary aspect of the present invention is a control method of a battery pack including secondary battery cells,

the control method including:

detecting a state value indicating a state of the battery pack;

determining whether or not an abnormality has occurred in the battery pack based on the state value, and if an abnormality has occurred, transmitting an abnormality signal indicating the occurrence of abnormality to an external device, and subsequently after a predefined delay time passes, outputting an interruption instruction to interrupt the current flow between the secondary battery cells and the external device; and

interrupting the current flow between the secondary battery cells and the external device if the interruption instruction is outputted,

wherein the delay time is five or more seconds.

### Effect of Invention

According to the present invention, it is possible to reduce destabilization of driving.

### BRIEF DESCRIPTION OF DRAWINGS

FIG. 1 is a block diagram showing a configuration of a battery pack of one exemplary embodiment.

FIG. 2 is a block diagram showing a configuration of a mobile body of one exemplary embodiment.

FIG. 3 is a drawing explaining an example of operation of the battery pack and the mobile body of one exemplary embodiment.

### EXEMPLARY EMBODIMENT

An exemplary embodiment will be described with reference to drawings, hereinafter. In the following description, the same reference numerals are used for components that have the same functions, and description thereof may be omitted.

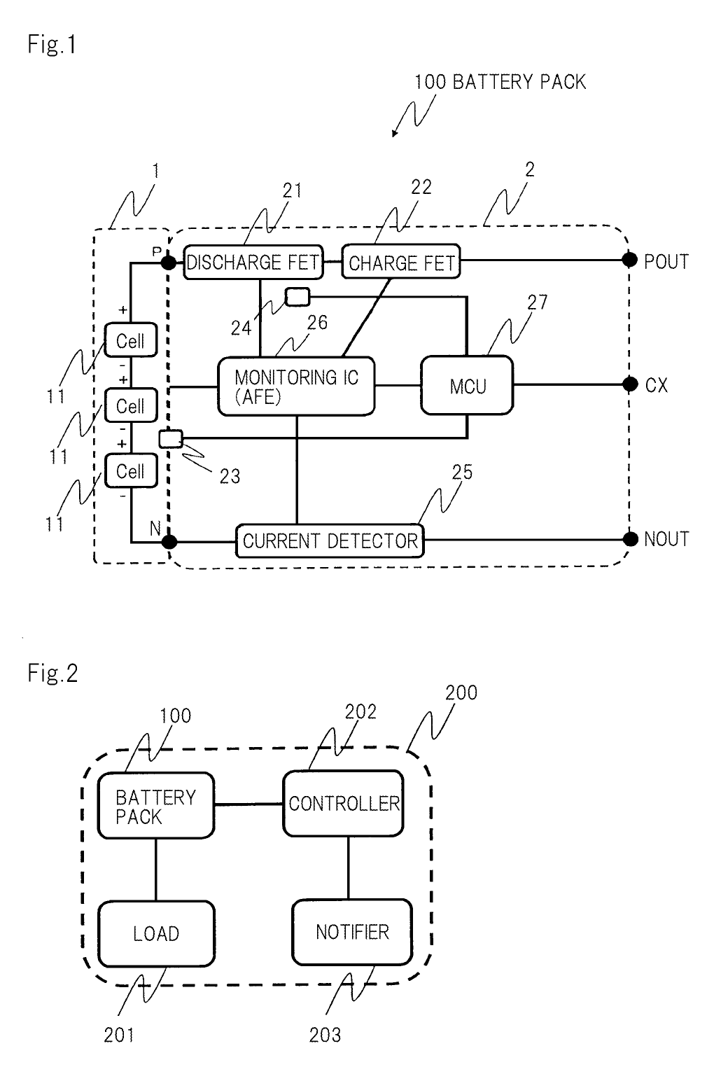

FIG. 1 is a block diagram showing a configuration of a battery pack of one exemplary embodiment. In FIG. 1, battery pack 100 includes battery section 1, and battery management unit (BMU) 2. Battery pack 100 is connected to electric equipment (not shown in FIG. 1), and functions as a power source of the electric equipment. The electric equipment is a mobile body, such as a power assisted electric bicycle, an electric motor cycle, and an electric vehicle.

Battery section 1 includes secondary battery cells 11 that are chargeable and dischargeable, positive electrode terminal P, and negative electrode terminal N.

In the present exemplary embodiment, battery section 1 is formed by a plurality of secondary battery cells 11 connected in series. However, battery section 1 may be formed by a single secondary battery cell, or may be formed by a plurality of secondary battery cells connected in parallel or in a matrix configuration. The number or arrangement of the secondary battery cells may be appropriately defined based on the type of the electric equipment and the type of the secondary battery cells, and others.

The type of the secondary battery cells 11 is not limited to a specific one, but may be lithium ion secondary battery cells, for example. An example of lithium ion secondary battery cells may include manganese-based lithium ion secondary battery cells whose positive electrodes include manganese, or ternary lithium ion battery cells whose positive electrodes include cobalt, nickel, and manganese.

Battery management unit 2 is connected to battery section 1 (specifically, to positive electrode terminal P and negative electrode terminal N) so as to protect the electric equipment connected to battery section 1 and battery pack 100.

Specifically, battery management unit 2 includes: discharge FET (field effect transistor) 21; charge FET 22; temperature sensors 23, 24; current detector 25; monitoring IC (integrated circuit) 26, and MCU (micro control unit) 27. Battery management unit 2 includes: positive electrode output terminal POUT and negative electrode output terminal NOUT that are used for supplying and receiving electric power to the electric equipment; and communication terminal CX used for providing communication with the electric equipment. Plurality of communication terminals CX may be provided.

Discharge FET 21 and charge FET 22 serve as a switch to switch over connection and interrupt current flow between battery section 1 (specifically, secondary battery cells 11) and the external device. Specifically, discharge FET 21 is a switch to control discharge current outputted from battery section 1, and charge FET 22 is a switch to control charge current to be supplied to battery section 1.

In FIG. 1, discharge FET 21 and charge FET 22 are disposed between positive electrode terminal P of battery section 1 and positive electrode output terminal POUT, but may be disposed between negative electrode terminal N of battery section 1 and negative electrode output terminal NOUT. As the switch to control discharge current and charge current, a breaker or a relay may be used instead of the FETs.

Temperature sensors 23 and 24, current detector 25, and monitoring IC 26 serve as a detector for detecting a state value that indicates the state of battery pack 100. As a state value, the detector may detect at least one of a cell voltage value that is a voltage value between both electrodes of secondary battery cells 11, a cell current value that is a value of a discharge current flowing to secondary battery cells 11, and a pack temperature that is a temperature of the battery pack; but in the present exemplary embodiment, the detector is configured to detect all the above state values. As the pack temperature, the detector may detect at least one of a cell temperature that is a temperature of battery section 1, and a switch temperature that is a temperature of the switch (discharge FET 21 and charge FET 22); but in the present exemplary embodiment, the detector is configured to detect both the above pack temperatures.

Temperature sensor 23 detects the cell temperature that is the temperature of battery section 1. Temperature sensor 23 may include plural sensors. In such a case, each temperature sensor 23 measures the temperature at each different position of battery section 1.

Temperature sensor 24 detects the switch temperature that is the temperature of discharge FET 21 and charge FET 22. Temperature sensor 24 may include plural sensors. In such a case, each temperature sensor 24 measures each temperature of discharge FET 21 and charge FET 22.

Current detector 25 detects the charge current and the discharge current of battery section 1. In the present exemplary embodiment, current detector 25 is disposed between negative electrode terminal N of battery section 1 and negative electrode output terminal NOUT, but may be disposed between positive electrode terminal P of battery section 1 and positive electrode output terminal POUT. The charge current and the discharge current of battery section 1 may also be collectively referred to as a charge/discharge current, hereinafter.

Monitoring IC 26 functions as a detector to detect the cell voltage value that is the voltage between both electrodes of each secondary battery cell 11, and functions as an interrupter to interrupt current flow between battery section 1 and external device using discharge FET 21 and charge FET 22. Monitoring IC 26 may also be referred to as an analog front end (AFE).

In the case of functioning as a stopper, specifically if an interruption instruction to interrupt current flow between battery section 1 and external device is outputted from MCU 27, monitoring IC 26 turns off discharge FET 21 or charge FET 22, or both discharge FET 21 and charge FET 22 so as to interrupt current flow between battery section 1 and external device.

MCU 27 may also be referred to as a manager. Based on the detected state values (i.e., the cell temperature and the switch temperature detected by temperature sensors 23 and 24, the charge/discharge current detected by current detector 25, and the cell voltage value detected by monitoring IC 26), MCU 27 determines whether or not an abnormality has occurred in battery pack 100.

Specifically, for each of the detected state values, MCU 27 determines whether or not the state value satisfies an abnormality condition corresponding to this state value, and if there is any state value that satisfies the corresponding abnormality condition, MCU 27 determines that an abnormality has occurred, and if there is no state value that satisfies the corresponding abnormality condition, MCU 27 determines that no abnormality has occurred.

If an abnormality has occurred, MCU 27 transmits an abnormality signal, that indicates the occurrence of an abnormality, to the external device via communication terminal CX. Subsequently, after a predefined delay time passes, MCU 27 outputs to monitoring IC 26 the interruption instruction to interrupt current flow between battery section 1 (specifically, secondary battery cells 11) and external device.

The delay time is preferably set so that there will be enough time for a user who uses a mobile body including battery pack 100 to confirm that power supply from battery pack 100 will be stopped, and specifically, this is preferably five or more seconds. It should be noted that an excessively long delay time may cause a problem in which secondary battery cells 11 become damaged, or the like; thus this does not mean that the delay time be preferably as long as possible. Hence, it is preferable that the delay time be within a range of five seconds to one minute.

MCU 27 may determine whether or not occurrence of an abnormality in battery pack 100 is predicted based on the state values. Specifically, for each of the state values, MCU 27 determines whether or not the state value satisfies a warning condition corresponding to this state value, and if there is any state value that satisfies the corresponding warning condition, MCU 27 determines that the occurrence of an abnormality can be predicted; and if none of the state values satisfies the corresponding warning condition, MCU 27 determines that the occurrence of an abnormality can be not predicted. If the occurrence of an abnormality can be predicted, MCU 27 transmits a warning signal indicating that the occurrence of an abnormality can be predicted to the external device via communication terminal CX.

Processing carried out by MCU 27 will be described in details as follows.

An example of an abnormality that occurs in the battery pack may include over discharge, discharge over current, abnormally high temperature, damage due to open circuit, and disconnection, for example. Processing for each type of abnormality carried out by MCU 27 will be described, hereinafter.

### (1) Over Discharge

In the case of using lithium ion secondary battery cells as secondary battery cells 11, there may be caused a problem may arise in which an excessive decrease in the voltage value of secondary battery cells 11 due to discharge causes the deterioration of the secondary battery cells, and heat may be generated during charging.

Hence, the abnormality condition corresponding to the cell voltage value is preferably such that the cell voltage value does not exceed a first voltage threshold value. In this case, MCU 27 determines that an abnormality has occurred if the cell voltage value does not exceed the first voltage threshold value, and then keeps transmitting the abnormality signal until the delay time passes, and subsequently, outputs the interruption instruction to monitoring IC 26, thereby causing monitoring IC 26 to interrupt current flow between battery section 1 and the external device.

A deep discharge voltage value as a voltage value that might cause trouble during charge, and a discharge termination voltage value whose voltage value becomes a high discharge voltage value when the secondary battery cells are left for a certain time period (e.g., several months to several years) without being charged vary depending on the type of the secondary battery cells, etc., but in general, these values are approximately 1 V and 3 V, respectively. In this case, if it is assumed that no delay time is necessary, and the first voltage threshold value is approximately 2.3 V, even if the cell voltage value decreases until current flow between battery section 1 and the external device is actually interrupted after the cell voltage value does not exceed the first voltage threshold value, it is possible to reduce deterioration of the secondary battery cells.

However, in the present exemplary embodiment, the delay time is necessary, and thus it is preferable to set the first voltage threshold value to be higher than 2.3 V. The above first voltage threshold value is defined depending on the characteristics of secondary battery cells 11, and the first voltage threshold value is preferably within a range of 2.5 V to 2.9 V, for example.

An example of the warning condition corresponding to the cell voltage value may be such that the cell voltage value exceeds the first voltage threshold value, and does not exceed a second voltage threshold value that is higher than the first voltage threshold value, for example. In this case, MCU 27 transmits the warning signal to the external device via communication terminal CX if the cell voltage value exceeds the first voltage threshold value, and does not exceed the second voltage threshold value that is higher than the first voltage threshold value. The second voltage threshold value is within a range of 2.9 V to 3.3 V, for example.

### (2) Discharge Over Current

During discharge of the secondary battery cells, if current that is a previously expected maximum current value or more is discharged from the secondary battery cells, the secondary battery may become deteriorated or damaged.

Hence, the abnormality condition corresponding to the cell current value is preferably such that the cell current value is not smaller than a first current threshold value, for example. In this case, MCU 27 determines that an abnormality has occurred if the cell current value is not smaller than the first current threshold value, and then keeps transmitting the abnormality signal until the delay time passes, and subsequently, outputs the interruption instruction to monitoring IC 26, thereby causing monitoring IC 26 to interrupt current flow between battery section 1 and the external device.

Although the first current threshold value varies depending on the characteristics of secondary battery cells 11, if the maximum value of the cell current value in which operation of secondary battery cells 11 is guaranteed is 20 A, the first current threshold value is within a range of 25 A to 40 A, for example.

An example of the warning condition corresponding to the cell current value may be such that the cell current value is smaller than the first current threshold value, and not smaller than a second current threshold value that is smaller than the first current threshold value. In this case, MCU 27 transmits the warning signal to the external device via communication terminal CX if the cell current value is smaller than the first current threshold value, and not smaller than the second current threshold value that is smaller than the first current threshold value. If the maximum value of the cell current value in which operation of secondary battery cells 11 is guaranteed is 20 A, the second current threshold value is within a range of 20 A to 35 A, for example.

### (3) Abnormally High Temperature

If battery pack 100, specifically, secondary battery cells 11 and the switch (discharge FET 21 and charge FET 22) have an excessively high temperature, secondary battery cells 11 and the switch may be deteriorated or damaged.

Hence, an abnormal condition corresponding to the cell temperature is preferably such that the cell temperature is not lower than a first cell temperature threshold value, and an abnormal condition corresponding to the switch temperature is preferably such that the switch temperature is not lower than a first switch temperature threshold value. In this case, if the cell temperature value is not lower than the first cell temperature threshold value, or the switch temperature is not lower than the first switch temperature threshold value, MCU 27 determines that an abnormality has occurred, and then keeps transmitting the abnormality signal until the delay time passes, and thereafter, outputs the interruption instruction to monitoring IC 26 so as to cause monitoring IC 26 to interrupt current flow between battery section 1 and the external device.

The first cell temperature threshold value varies depending on the characteristics of secondary battery cells 11, and if the maximum value of the operation guarantee temperature of secondary battery cells 11 is 60° C., the first cell temperature threshold value is within a range of 60° C. to 70° C., for example. The first switch temperature threshold value varies depending on the characteristics of the switch, and the first switch temperature threshold value is within a range of 90° C. to 110° C. if the junction temperature of the FET that is the switch is 150° C., for example.

The warning condition corresponding to the cell temperature may be such that the cell temperature is lower than the first cell temperature threshold value, and not lower than a second cell temperature threshold value that is lower than the first cell temperature threshold value. The warning condition corresponding to the switch temperature may be such that the switch temperature is lower than the first switch temperature threshold value, and not lower than a second switch temperature threshold value that is lower than the first switch temperature threshold value. In this case, MCU 27 transmits the warning signal to the external device via communication terminal CX if the cell temperature is lower than the first cell temperature threshold value, and not lower than the second cell temperature threshold value that is lower than the first cell temperature threshold value; or if the switch temperature is lower than the first switch temperature threshold value, and not lower than the second switch temperature threshold value that is lower than the first switch temperature threshold value as the warning condition corresponding to the switch temperature.

The second cell temperature threshold value is within a range of 45° C. to 60° C. if the maximum value of the operation guarantee temperature of secondary battery cells 11 is 60° C., for example. The second switch temperature threshold value is within a range of 70° C. to 90° C. if the junction temperature of the FET that is the switch is 150° C., for example.

In the case of using NTC thermistors (negative temperature coefficient thermistors) as temperature sensors 23 and 24, if damage due to a short circuit occurs in temperature sensor 23 or 24, an extremely high cell temperature or switch temperature is detected. In such a case, the cell temperature or the switch temperature becomes not lower than the first cell temperature threshold value or not lower than the first switch temperature threshold value, and thus it is detected as an abnormality.

### (4) Damage Due to Open Circuit

In the case of using the NTC thermistors as temperature sensors 23 and 24, if damage due to open circuit occurs in temperature sensor 23 or 24, an extremely low pack temperature (cell temperature or switch temperature) is detected.

The abnormality condition corresponding to the pack temperature preferably includes a condition in which the pack temperature is not higher than the pack temperature threshold value. In this case, MCU 27 determines that an abnormality has occurred if the pack temperature value is not higher than the pack temperature threshold value, and then keeps transmitting the abnormality signal until the delay time passes, and thereafter, outputs the interruption instruction to monitoring IC 26, thereby causing monitoring IC 26 to interrupt current flow between battery section 1 and the external device. The pack temperature threshold value is within a range of −15° C. to −25° C. if the minimum value of the operation guarantee temperature of the battery pack 100 is −10, for example.

A situation will never occur in which the actual temperature suddenly increases due to breakage of the temperature sensor and thus it is possible to ensure a delay time of five or more seconds.

In the determination of each of the aforementioned abnormalities (1) to (4), the state value temporarily becomes an abnormal value for a certain reason. In such a case, if current flow between secondary battery cells 11 and the external device is interrupted, power supply to the external device will be stopped even breakage of secondary battery cells 11 does not occur, which causes inconvenience.

To solve this, it is preferable that for each of the state values, MCU 27 determines whether or not the state value continuously satisfies the corresponding abnormality condition during a predefined insensitive time, and if there is any state value that continuously satisfies the corresponding abnormality condition during the insensitive time, MCU 27 determines that an abnormality has occurred.

The insensitive time is a time used to prevent erroneous determination of an abnormality, and is a value within five seconds, for example.

### (5) Disconnection

Monitoring IC 26 is required to be connected to the both electrodes of secondary battery cells 11 via lines in order to detect the cell voltage value of secondary battery cells 11. If the lines are disconnected, monitoring IC 26 cannot detect the cell voltage value, and detection of the cell voltage value is stopped.

For this reason, in MCU 27, an abnormality condition that corresponds to the cell voltage value is set such that detection of the cell voltage value is stopped, and MCU 27 determines that an abnormality has occurred if detection of the cell voltage value is stopped.

Even if lines connecting monitoring IC 26 and the both electrodes of secondary battery cells 11 become disconnected, a situation will never occur in which the cell voltage value of the secondary battery cells is abruptly decreased because of this disconnection. Accordingly, it is possible to ensure a delay time of five or more seconds. Usually, disconnection occurs without warning and thus it is not necessary to set the warning condition and the insensitive time regarding the disconnection.

A mobile body including battery pack 100 will be described, hereinafter.

FIG. 2 is a block diagram showing an example of a configuration of the electric equipment including battery pack 100. Mobile body 200 as shown in FIG. 2 includes battery pack 100, load 201, controller 202, and notifier 203.

Load 201 is connected to positive electrode output terminal POUT and negative electrode output terminal NOUT of battery pack 100, and is driven by electric power supplied from battery pack 100 via positive electrode output terminal POUT and negative electrode output terminal NOUT. An example of load 201 may include a motor of an electric vehicle or of a power assisted electric bicycle, etc.

Controller 202 is connected to communication terminal CX of battery pack 100, and receives an abnormality signal and the warning signal from battery pack 100 via communication terminal CX.

Upon receiving the warning signal, controller 202 uses notifier 203 to notify a user that occurrence of an abnormality is predicted.

Upon receiving an abnormality signal, controller 202 uses notifier 203 to provide notification that the supply of electric power from battery pack 100 will be stopped. At this time, controller 202 may notify remaining time before the electric power supply from battery pack 100 is stopped, or the like.

The notifier may be a monitor, a speaker, or vibrations, etc., for example. Battery pack 100 may be detachably attached to mobile body 200. Mobile body 200 may also include an auxiliary power source different from battery pack 100.

Operation of battery pack 100 and mobile body 200 will be described, hereinafter. The following operation is periodically carried out.

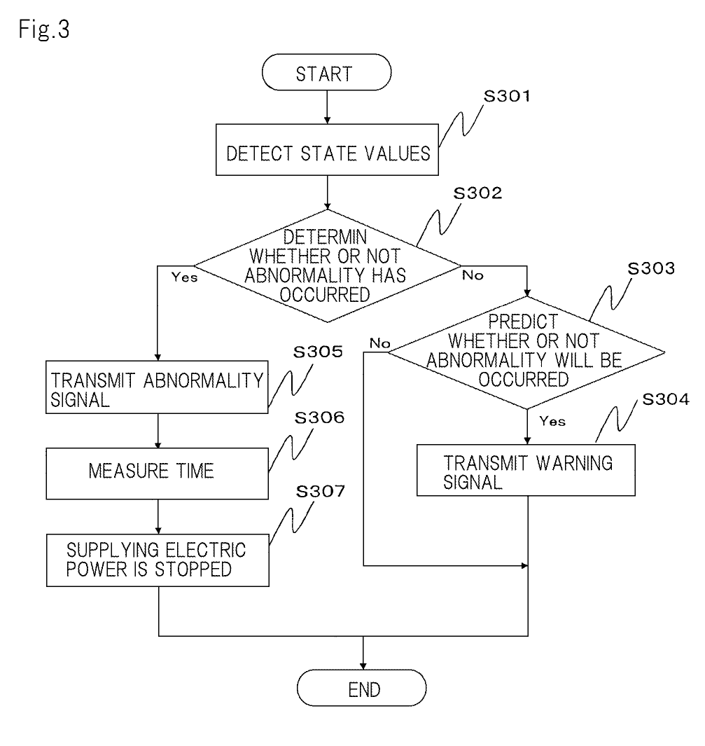

FIG. 3 is a flow chart used for explaining an example of the operation of battery pack 100.

First, temperature sensor 23 detects the cell temperature that is the temperature of battery section 1, and notifies monitoring IC 26 of a cell temperature signal indicating this cell's temperature. Temperature sensor 24 detects the switch temperature that is the temperature of the switch, and notifies monitoring IC 26 of the switch temperature signal indicating this switch temperature. Current detector 25 detects the charge/discharge current of battery section 1, and notifies monitoring IC 26 of a current signal indicating this charge/discharge current. Monitoring IC 26 detects the cell voltage of each secondary battery cell 11, and also receives the cell temperature signal, the switch temperature signal, and the current signal. Monitoring IC 26 notifies MCU 27 of the voltage signal indicating the cell voltage of each detected cell, and the cell temperature signal, the switch temperature signal, and the current signal that are respectively received (step S301).

When receiving the voltage signal, the cell temperature signal, the switch temperature signal, and the current signal, MCU 27 determines whether or not an abnormality has occurred in battery pack 100 based on the voltage signal, the cell temperature signal, the switch temperature signal, and the current signal (step S302).

If no abnormality has occurred, MCU 27 determines whether or not occurrence of abnormality in battery pack 100 is predicted based on the voltage signal, the cell temperature signal, the switch temperature signal, and the current signal (step S303).

If no occurrence of abnormality is predicted, MCU 27 terminates the processing.

However, if the occurrence of an abnormality is predicted, MCU 27 transmits the warning signal to controller 202 of mobile body 200 via communication terminal CX (step S304), and then terminates the processing. In this case, when receiving the warning signal, controller 202 notifies the user that the occurrence of an abnormality is predicted using notifier 203.

If the abnormality has occurred in step S302, MCU 27 transmits the abnormality signal to controller 202 of mobile body 200 via communication terminal CX (step S305). In this case, when receiving the abnormality signal, controller 202 uses notifier 203 to notify the user that the electric power supply from battery pack 100 will be stopped.

When the abnormality signal is transmitted in step S305, MCU 27 measures time until the delay time passes (step S306).

After the delay time passes, MCU 27 transmits the interruption instruction to monitoring IC 26. When receiving the interruption instruction, monitoring IC 26 turns off discharge FET 21 or charge FET 22, or both discharge FET 21 and charge FET 22 in order to interrupt between battery section 1 and the external device (step S307), and then terminates the processing. In this manner, the electric power supply to load 201 of mobile body 200 is stopped.

As aforementioned, according to the present exemplary embodiment, if an abnormality occurs, the abnormality signal indicating the occurrence of abnormality is transmitted to the external device, and subsequently after five or more seconds pass, the flow of current between secondary battery cells 11 and the external device is interrupted. Therefore, it is possible to ensure that there is enough time to notify the user about the status of the electric power supply before the electric power supply is stopped. Accordingly, it is possible to recognize in advance a change in the load that is to be applied to pedals of a power assisted electric bicycle or the steering wheel of an electric vehicle, and thereby reduce unstable driving conditions.

In the present exemplary embodiment, if occurrence of an abnormality is predicted, the warning signal is outputted, thus making it possible to more securely reduce unstable driving conditions.

In the aforementioned exemplary embodiment, the configurations shown in the drawings are merely an example of the exemplary embodiment, and the present invention is not limited to the above configurations.

Part or all of the aforementioned exemplary embodiment may be described as the following Appendixes, but is not limited to the following.

### APPENDIX 1

A battery pack including secondary battery cells,

the battery pack comprising:

a switch that switches between starting and stopping the current flow between the secondary battery cells and an external device;

a detector that detects a state value indicating a state of the battery pack;

a manager that determines whether or not an abnormality has occurred in the battery pack based on the state value, and if the abnormality has occurred, transmits an abnormality signal indicating the occurrence of the abnormality to an external device, and subsequently after a predefined delay time passes, outputs an interruption instruction to interrupt the current flow between the secondary battery cells and the external device; and

an interrupter that interrupts the current flow between the secondary battery cells and the external device via the switch if the interruption instruction is outputted,

wherein the delay time is five or more seconds.

### APPENDIX 2

The battery pack as set forth in Appendix 1, wherein

as the state value, the detector detects one or more from among a cell voltage value that is a voltage value between both electrodes of the secondary battery cells, a cell current value that is a value of discharge current flowing to the secondary battery cells and a pack temperature that is a temperature of the battery pack.

### APPENDIX 3

The battery pack as set forth in Appendix 2, wherein

for each of the detected state values, the manager determines whether or not the detected state value satisfies an abnormality condition corresponding to the state value, and if there is any state value satisfying the corresponding abnormality condition, the manager determines that an abnormality has occurred.

### APPENDIX 4

The battery pack as set forth in Appendix 3, wherein

the abnormality condition corresponding to the cell voltage value includes the condition in which the cell voltage value is not higher than a first voltage threshold value, and

the manager transmits a warning signal indicating that the occurrence of an abnormality is predicted to the external device if the cell voltage value is higher than the first voltage threshold value, and not higher than a second voltage threshold value that is higher than the first voltage threshold value.

### APPENDIX 5

The battery pack as set forth in Appendix 4, wherein

the first voltage threshold value is within a range of 2.5 V to 2.9 V, and

the second voltage threshold value is within a range of 2.9 V to 3.2 V.

### APPENDIX 6

The battery pack as set forth in any one of Appendixes 3 to 5, wherein

the abnormality condition corresponding to the cell current value includes the condition in which the cell current value is not smaller than a first current threshold value, and

the manager transmits to the external device a warning signal indicating that the occurrence of an abnormality is predicted if the cell current value is smaller than the first current value, and not smaller than a second current threshold value that is smaller than the first current value.

### APPENDIX 7

The battery pack as set forth in Appendix 6, wherein

the first current threshold value is within a range of 25 A to 40 A, and

the second current threshold value is within a range of 20 A to 35 A.

### APPENDIX 8

The battery pack as set forth in any one of Appendixes 3 to 7, wherein

as the pack temperature, the detector detects one or more temperature values from among a cell temperature that is a temperature of the secondary battery cells and a switch temperature that is a temperature of the switch.

### APPENDIX 9

The battery pack as set forth in Appendix 8, wherein

the abnormality condition corresponding to the cell temperature includes the condition in which the cell temperature is not lower than the first cell temperature threshold value, and

the manager transmits to the external device the warning signal indicating that the occurrence of an abnormality is predicted if the cell temperature is lower than the first cell temperature threshold value, and not lower than a second cell temperature threshold value that is lower than the first cell temperature threshold value.

### APPENDIX 10

The battery pack as set forth in Appendix 9, wherein

the first cell temperature threshold value is within a range of 60° C. to 70° C., and

the second cell temperature threshold value is within a range of 45° C. to 65° C.

### APPENDIX 11

The battery pack as set forth in Appendix 8, wherein

the abnormality condition corresponding to the switch temperature includes the condition in which the switch temperature is not lower than a first switch temperature threshold value, and

the manager transmits to the external device the warning signal indicating that the occurrence of an abnormality is predicted if the switch temperature is lower than the first switch temperature threshold value, and not lower than a second switch temperature threshold value that is lower than the first switch temperature threshold value.

### APPENDIX 12

The battery pack as set forth in Appendix 11, wherein

the first switch temperature threshold value is within a range of 90° C. to 110° C., and

the second switch temperature threshold value is within a range of 70° C. to 90° C.

### APPENDIX 13

The battery pack as set forth in any one of Appendixes 3 to 12, wherein

the abnormality condition corresponding to the pack temperature includes the condition in which the pack temperature is not higher than a pack temperature threshold value.

### APPENDIX 14

The battery pack as set forth in Appendix 13, wherein

the pack temperature threshold value is within a range of −15° C. to −25° C.

### APPENDIX 15

The battery pack as set forth in any one of Appendixes 3 to 14, wherein

for each of the detected state values, the manager determines whether or not the detected state value continuously satisfies the abnormality condition during a predefined insensitive time, and if there is any state value satisfying the abnormality condition during the insensitive time, the manager determines that an abnormality has occurred.

### APPENDIX 16

The battery pack as set forth in Appendix 15, wherein

the insensitive time is a value within five seconds.

### APPENDIX 17

The battery pack as set forth in any one of Appendixes 3 to 16, wherein

the abnormality condition corresponding to the cell voltage value includes the condition in which detection of the cell voltage value is stopped.

### APPENDIX 18

The battery pack as set forth in any one of Appendixes 1 to 17, wherein

the secondary battery cells are manganese spinel-based lithium ion secondary battery cells whose positive electrodes include manganese.

### APPENDIX 19

A mobile body comprising:

the battery pack as set forth in any one of Appendixes 1 to 18;

a notifier;

a controller that notifies that an abnormality has occurred in the battery pack via the notifier if an abnormality signal is outputted from the battery pack.

### APPENDIX 20

A control method of a battery pack including secondary battery cells,

the control method comprising:

detecting a state value indicating a state of the battery pack;

determining whether or not an abnormality has occurred in the battery pack based on the state value, and if an abnormality has occurred, transmitting an abnormality signal indicating the occurrence of the abnormality to an external device, and subsequently after a predefined delay time passes, outputting an interruption instruction to interrupt the current flow between the secondary battery cells and the external device; and

interrupting the current flow between the secondary battery cells and the external device if the interruption instruction is outputted,

wherein the delay time is five or more seconds.

This application is based upon and claims the benefit of priority from Japanese patent application No. 2013-050084, filed on Mar. 13, 2013, the disclosure of which is incorporated herein in its entirety by reference.

### REFERENCE SIGNS LIST

1 battery section
2 battery management unit
11 secondary battery cell
21 discharge FET
22 charge FET
23 temperature sensor
24 temperature sensor
25 current detector
26 monitoring IC
27 MCU
100 battery pack
200 mobile body
201 load
202 manager
203 notifier

1. A battery pack including secondary battery cells,
said battery pack comprising:
a switch that switches between starting and stopping the current flow between said secondary battery cells and an external device;
a detector that detects a state value that indicates a state of said battery pack;
a manager that determines whether or not an abnormality has occurred in said battery pack based on the state value, and if the abnormality has occurred, transmits an abnormality signal indicating the occurrence of abnormality to the external device, and subsequently after a predefined delay time passes, outputs an interruption instruction to interrupt the current flow between said secondary battery cells and the external device; and
an interrupter that interrupts the current flow between said secondary battery cells and the external device via said switch if the interruption instruction is outputted,
wherein the delay time is five or more seconds.

2. The battery pack according to claim 1, wherein
as the state value, said detector detects one or more from among a cell voltage value that is a voltage value between both electrodes of said secondary battery cells, a cell current value that is a value of discharge current flowing to said secondary battery cells and a pack temperature that is a temperature of said battery pack.

3. The battery pack according to claim 2, wherein
for each of the detected state values, said manager determines whether or not the detected state value satisfies an abnormality condition corresponding to the state value, and if there is any state value satisfying the corresponding abnormality condition, said manager determines that the abnormality has occurred.

4. The battery pack according to claim 3, wherein
the abnormality condition corresponding to the cell voltage value includes the condition in which the cell voltage value is not higher than a first voltage threshold value, and
said manager transmits a warning signal indicating that the occurrence of an abnormality is predicted to the external device if the cell voltage value is higher than the first voltage threshold value, and not higher than a second voltage threshold value that is higher than the first voltage threshold value.

5. The battery pack according to claim 4, wherein
the first voltage threshold value is within a range of 2.5 V to 2.9 V, and
the second voltage threshold value is within a range of 2.9 V to 3.2 V.

6. The battery pack according to claim 3, wherein
the abnormality condition corresponding to the cell current value includes the condition in which the cell current value is not smaller than a first current threshold value, and
said manager transmits to the external device a warning signal indicating that the occurrence of an abnormality is predicted if the cell current value is smaller than the first current value, and not smaller than a second current threshold value that is smaller than the first current value.

7. The battery pack according to claim 6, wherein
the first current threshold value is within a range of 25 A to 40 A, and
the second current threshold value is within a range of 20 A to 35 A.

8. The battery pack according to claim 3, wherein
as the pack temperature, said detector detects one or more from among a cell temperature that is a temperature of said secondary battery cells and a switch temperature that is a temperature of said switch.

9. A mobile body comprising:
said battery pack according to claim 1;
a notifier;
a controller that notifies that an abnormality has occurred in said battery pack via said notifier if an abnormality signal is outputted from said battery pack.

10. A control method of a battery pack including secondary battery cells,
the control method comprising:
detecting a state value indicating a state of said battery pack;
determining whether or not an abnormality has occurred in said battery pack based on the state value, and if an abnormality has occurred, transmitting an abnormality signal indicating the occurrence of abnormality to an external device, and subsequently after a predefined delay time passes, outputting an interruption instruction to interrupt the current flow between said secondary battery cells and the external device; and
interrupting the current flow between said secondary battery cells and the external device if the interruption instruction is outputted,
wherein the delay time is five or more seconds.
